(19) United States
(12) Patent Application Publication
(10) Pub. No.: US 2008/0248357 A1
(43) Pub. Date: Oct. 9, 2008

(54) Fuel cell seal and fuel cell

(76) Inventors: Takahiro Terada, Kanagawa-ken (JP); Yasutada Nakagawa, Kanagawa-ken (JP); Yuji Sasaki, Kanagawa-ken (JP); Yuichi Yoshida, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/812,542

(22) Filed: Jun. 20, 2007

(30) Foreign Application Priority Data
Jun. 20, 2006 (JP) 2006-169875

(51) Int. Cl. H01M 2/08; H01M 8/10

(52) U.S. Cl. 429/30; 429/35

(57) ABSTRACT

A fuel cell seal includes: a first seal member having a first protrusion in a major surface thereof; and a second seal member having a recess in a major surface thereof. The recess is engageable with at least part of the first protrusion. A fuel cell includes: a solid electrolytic film; a first and second seal member placed on both major surface sides of the solid electrolytic film, respectively, and opposed to each other; a fuel electrode placed on a side of the first seal member, the side being opposite to the solid electrolytic film; and an oxidizer electrode placed on a side of the second seal member, the side being opposite to the solid electrolytic film. One of the first and the second seal members has a first protrusion. Other of the first and the second seal members has a recess engageable with at least part of the first protrusion. The first and the second seal members are engaged with each other across the solid electrolytic film.

### CROSS-REFERENCE TO RELATED APPLICATIONS

This application is based upon and claims the benefit of priority from the prior Japanese Patent Application No. 2006-169875, filed on Jun. 20, 2006; the entire contents of which are incorporated herein by reference.

### BACKGROUND OF THE INVENTION

1. Field of the Invention

This invention relates to a fuel cell seal and a fuel cell where fuel leakage is reduced.

2. Background Art

Recently, office automation (OA), audio, wireless and other systems become more compact and require further portability with the advancement of semiconductor technologies. As a power supply for meeting such requirement, primary and secondary cells are conveniently used. However, primary and secondary cells are functionally limited in operating time. Hence OA and other systems using these cells are naturally limited in operating time.

In the case of primary cells used in OA or other systems, after the cell finishes discharging, the system can be operated again by replacing the cell. However, the operating time of the primary cell is short for its weight, and hence it is not suitable to portable devices. On the other hand, a secondary cell can be charged after finishing discharging. However, because secondary cells need a power supply for charging, they are unfortunately limited in the place of use and take time for charging. In particular, OA or other systems with a built-in secondary cell have difficulty in replacing the cell after the cell finishes discharging, which inevitably limits the system operating time. Thus it is difficult to achieve long-time operation in various compact devices by improving conventional primary and secondary cells, and cells more suitable to long-time operation are required.

As a solution to these problems, fuel cells are drawing attention. Advantageously, fuel cells can generate electric power simply by being supplied with fuel and oxidizer. As another advantage, fuel cells can continuously generate power simply by replacing fuel. Hence, if the fuel cell can be downsized, it is very favorable to the operation of small devices such as low power consumption OA equipment. In particular, fuel cells using alcohol or other hydrocarbon liquid fuel can safely carry a fuel with high energy density, and hence are promising for application to electronic devices.

The structure of a fuel cell is described here with reference to FIG. 9. On a fuel tank 101, a porous film A 102, a fuel electrode 105, a solid electrolyte film 106, an oxidizer electrode 107, and a porous film B 108 are sequentially laminated. At the edge of the fuel cell, the portion without the fuel electrode 105 between the porous film A 102 and the solid electrolyte film 106 is provided with a fuel electrode side seal 103. Furthermore, at the edge of the fuel cell, the outer peripheral portion without the oxidizer electrode 107 between the porous film B 108 and the solid electrolyte film 106 is provided with an oxidizer electrode side seal 104.

The fuel cell is susceptible to fuel leakage because of its laminated structure of films. Fuel leakage increases cost, and also leads to failures in the electronic device. To avoid this, the fuel electrode side seal 103 and the oxidizer electrode side seal 104 are used for reducing the leakage. FIGS. 10 and 11 show conventional examples of the seal structure (as to FIG. 10, see e.g. JP 2004-303723A).

### SUMMARY OF THE INVENTION

According to an aspect of the invention, there is provided a fuel cell seal including: a first seal member having a first protrusion in a major surface thereof; and a second seal member having a recess in a major surface thereof, the recess being engageable with at least part of the first protrusion.

According to other aspect of the invention, there is provided a fuel cell including: a solid electrolytic film; a first and second seal member placed on both major surface sides of the solid electrolytic film, respectively, and opposed to each other; a fuel electrode placed on a side of the first seal member, the side being opposite to the solid electrolytic film; and an oxidizer electrode placed on a side of the second seal member, the side being opposite to the solid electrolytic film, one of the first and the second seal members having a first protrusion, other of the first and the second seal members having a recess engageable with at least part of the first protrusion, and the first and the second seal members being engaged with each other across the solid electrolytic film.

### BRIEF DESCRIPTION OF THE DRAWINGS

FIG. 1 is a plan view of a fuel cell seal according to a first and second embodiment of the invention.

FIG. 2 is a cross-sectional view of the fuel cell seal according to the first embodiment of the invention taken along the line Z-Z′ shown in FIG. 1.

FIG. 3 is a cross-sectional view of the fuel cell seal according to the second embodiment of the invention taken along the line Z-Z′ shown in FIG. 1.

FIG. 4 shows surface pressure distribution for the conventional fuel cell seal.

FIG. 5 shows surface pressure distribution for the fuel cell seal according to the first embodiment of the invention.

FIG. 6 shows surface pressure distribution for the fuel cell seal according to the second embodiment of the invention.

FIG. 7 is a graph showing how the surface pressure is related to the ratio of the recess height versus the seal height of the fuel cell seal in the first embodiment of the invention.

FIG. 8 shows the relationship between the rubber hardness and the surface pressure in the first embodiment of the invention.

FIG. 9 is a cross-sectional view of a common fuel cell.

FIG. 10 is a cross-sectional view of the conventional fuel cell seal portion in a fuel cell.

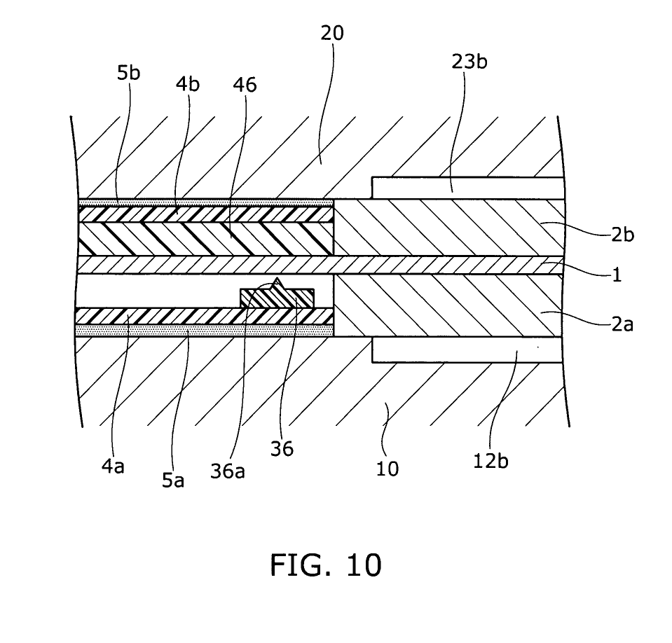

FIG. 11 is a cross-sectional view of the conventional fuel cell seal.

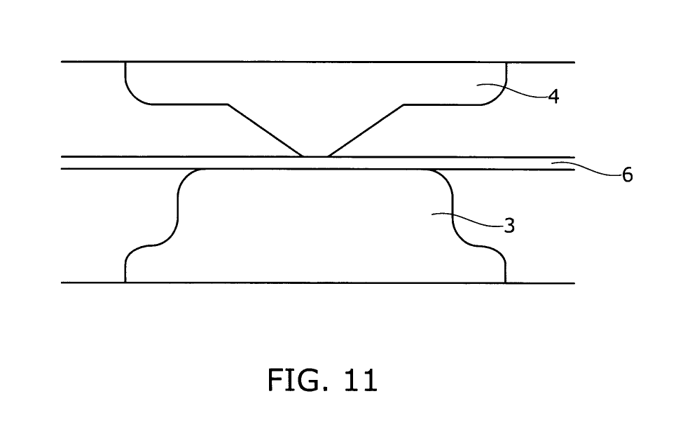

### DETAILED DESCRIPTION OF THE INVENTION

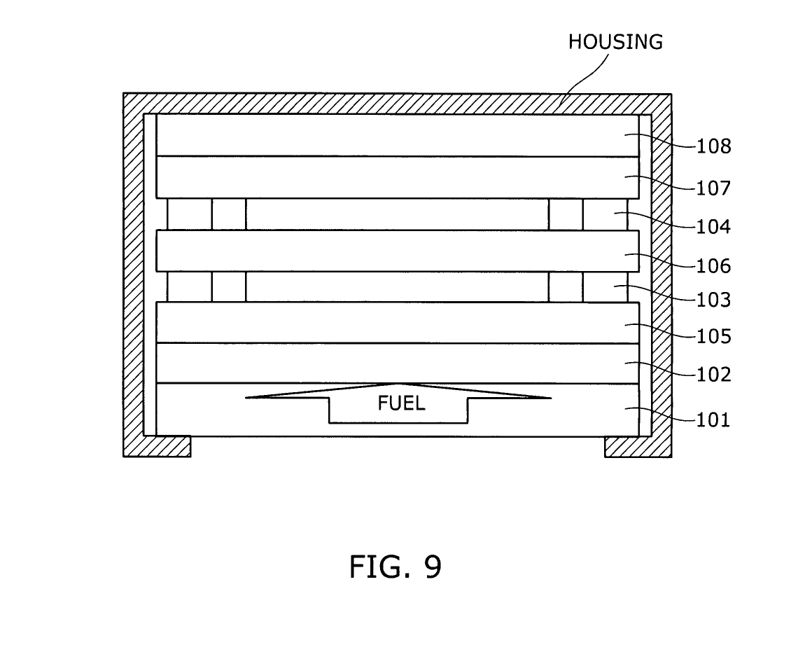

Embodiments of the invention will now be described with reference to the drawings. In the embodiments, the basic structure of the fuel cell is the same as shown in FIG. 9. Hence like components are marked with like reference numerals shown in FIG. 9. In the basic structure of the fuel cell according to the embodiments, on a fuel tank 101, a porous film A 102, a fuel electrode 105, a solid electrolyte film 106, an oxidizer electrode 107, and a porous film B 108 are sequentially laminated. At the edge of the fuel cell, the portion without the fuel electrode 105 between the porous film A 102 and the solid electrolyte film 106 is provided with a fuel electrode side seal. Furthermore, at the edge of the fuel cell, the outer peripheral portion without the oxidizer electrode 107 between the porous film B 108 and the solid electrolyte film 106 is provided with an oxidizer electrode side seal. The fuel cell seal used in the first and second embodiment is applied to the seals on the oxidizer electrode side and the fuel electrode side, and incorporated in a fuel cell having the same configuration as in FIG. 9.

First, the first embodiment of the invention is described.

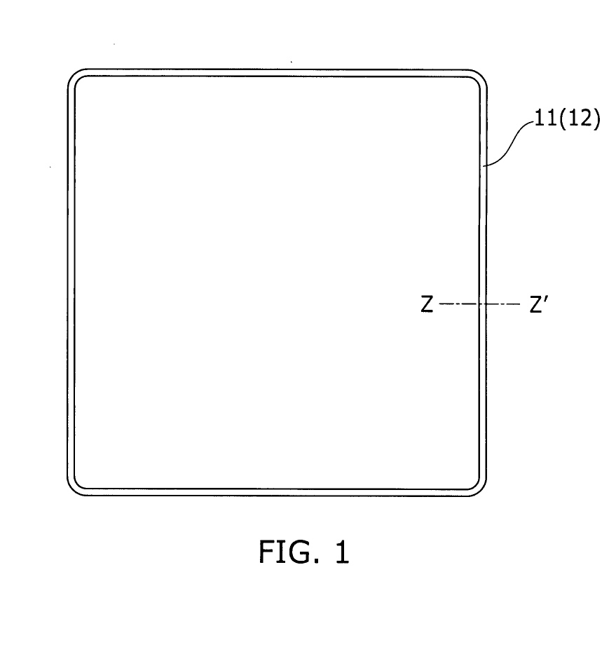

FIG. 1 is a plan view showing a fuel cell sealing member, that is, a fuel cell seal (fuel electrode side seal 11, oxidizer electrode side seal 12), according to the embodiment. By way of example, the fuel cell seal is shaped like a frame along the outer periphery of the fuel cell.

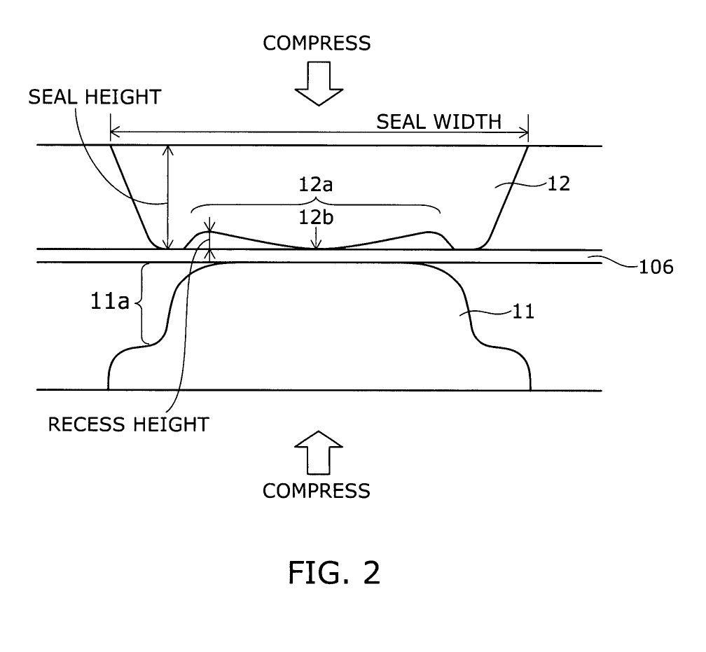

FIG. 2 is an example cross-sectional view of the fuel cell seal taken along Z-Z′, where the fuel electrode side seal 11 is opposed to the oxidizer electrode side seal 12 across the solid electrolyte film 106.

The fuel electrode side seal 11 has one protrusion 11a continuously extending along the frame-shaped periphery. The oxidizer electrode side seal 12 has a recess 12a continuously extending along the frame-shaped periphery. The recess 12a is shaped so that it can be engaged with the protrusion 11a of the fuel electrode side seal 11. A protrusion 12b is located at the center of the recess 12a and serves to decrease the contact area and to increase the surface pressure for enhancing sealing capability with respect to the solid electrolyte film 106. When the fuel electrode side seal 11 and the oxidizer electrode side seal 12 are compressed from above and below toward the solid electrolyte film 106 as shown in FIG. 2, these seals are engaged with each other across the solid electrolytic film 106. This can prevent misalignment between the fuel electrode side seal 11 and the oxidizer electrode side seal 12 and reduce fuel leakage. Furthermore, FIG. 2 shows an example cross-sectional configuration of the fuel electrode side seal 11 and the oxidizer electrode side seal 12. In the cross-sectional configuration of the oxidizer electrode side seal 12, elements of the seal configuration such as the height of the seal, the width of the seal, and the height of the recess are shown.

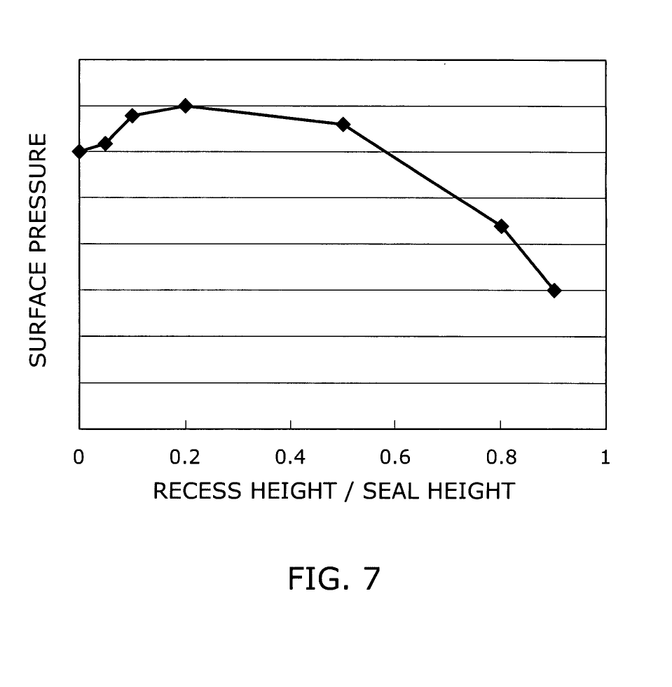

The ratio of (recess height/seal height), which is one of the elements of the seal configuration, is preferably in the range from 0.01 to 0.5. The detailed data is described with reference to FIG. 7, which shows the relationship between the ratio of recess height to seal height (recess height/seal height) and the surface pressure. It is found from this graph that a high surface pressure is achieved at or near the value of (recess height/seal height) equal to 0.2. In this embodiment, the ratio of seal height to seal width is set to 0.3.

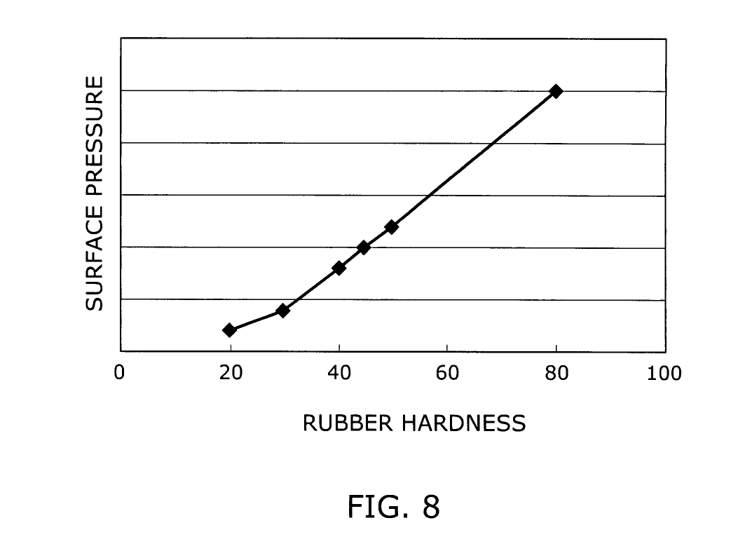

The fuel electrode side seal 11 and the oxidizer electrode side seal 12 of this embodiment can be made of elastic material, being resistant to the fuel for the fuel cell (e.g. rubbers such as ethylene propylene diene rubber (EPDM)). It is found as shown in FIG. 8 that, in the hardness range from 20 to 80 degrees, good sealing capability is achieved at a hardness of about 35 degrees or more. An extremely high hardness results in a high seal reaction force, which increases the possibility of distorting or destroying other members. Hence a hardness of 60 degrees or more is not preferable. Thus it is found that hardness near 50 degrees is preferable because of good sealing capability and no distortion/destruction of other members.

The second embodiment of the invention is described. The fuel cell of this embodiment has the same structure as the first embodiment. The seal is also the same as that shown in FIG. 2. However, the seal configuration is different in the cross-sectional configuration along Z-Z′ in FIG. 2.

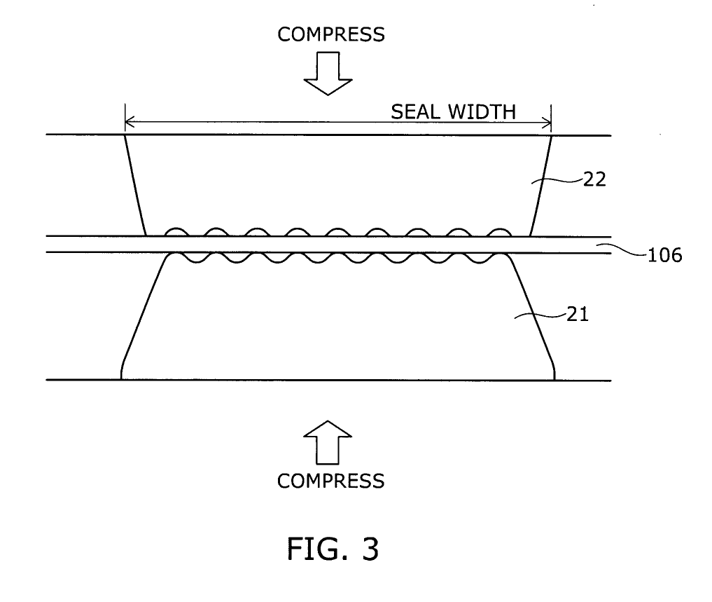

FIG. 3 is a cross-sectional view showing a fuel cell seal in a fuel cell. A fuel electrode side seal 21 is opposed to an oxidizer electrode side seal 22 across the solid electrolyte film 106. The fuel electrode side seal 21 has a plurality of protrusion/recess features in its surface. The oxidizer electrode side seal 22 also has a plurality of protrusion/recess features in its surface. The recesses (or protrusions) are spaced equidistantly (i.e. protrusions/recesses are repeated in a certain pattern). Furthermore, the spacing between the recesses and the spacing between the protrusions are the same. The protrusions/recesses are provided in the fuel electrode side seal 21 and the oxidizer electrode side seal 22 so as to continuously or intermittently extend along the frame-shaped periphery of the seal. The protrusion/recess features in the surface of the fuel electrode side seal 21 are engaged with the protrusion/recess features in the surface of the oxidizer electrode side seal 22 across the solid electrolytic film 106. Hence compression of these seals as in the first embodiment described above prevents misalignment therebetween. Thus fuel leakage can be reduced.

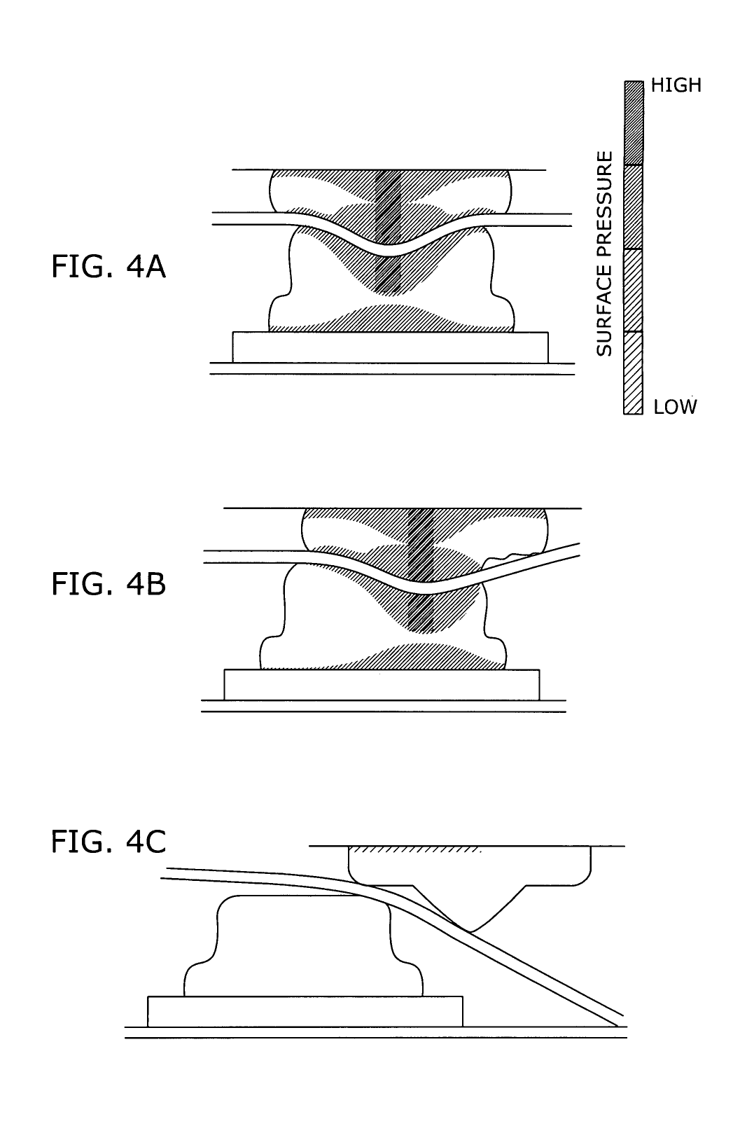

Effects of the first and second embodiment are described with reference to FIGS. 4 to 6. Denser hatching represents higher surface pressure. For equally dense hatching, longer hatching in the direction of applied pressure represents higher surface pressure.

FIG. 4 shows surface pressure distribution for the conventional seal configuration with the upper and lower seal being compressed to each other where the seals are at the design position (FIG. 4A), misaligned 10% from the design position (FIG. 4B), and misaligned 20% from the design position (FIG. 4C).

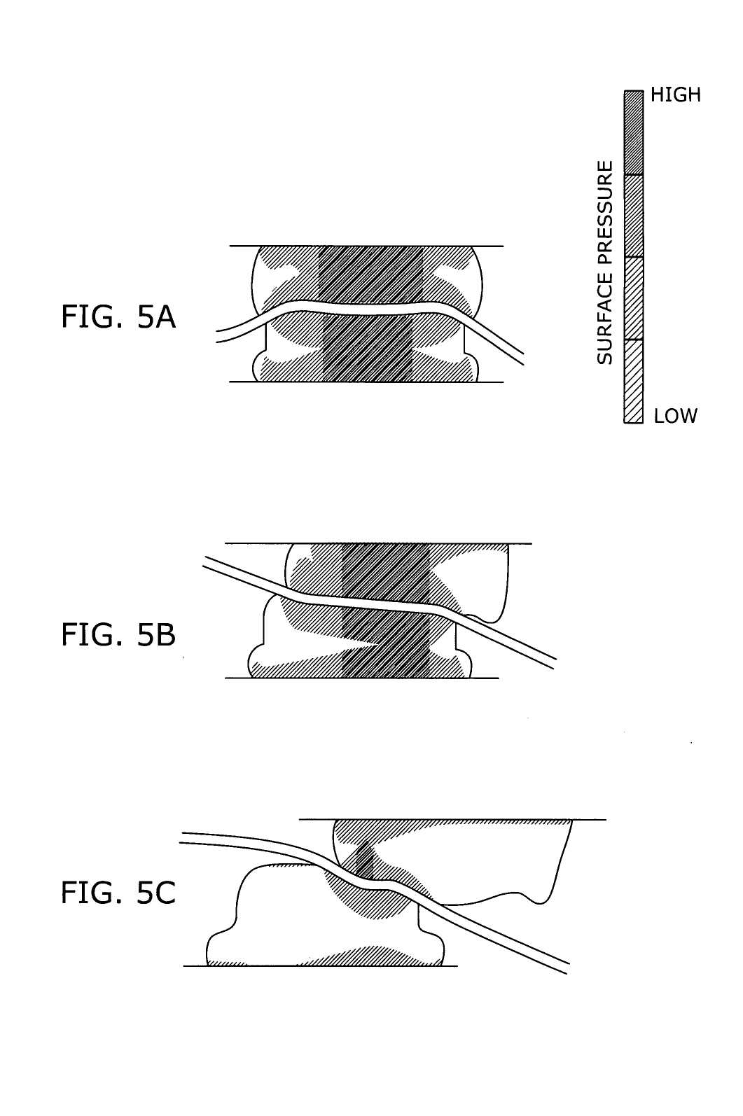

FIG. 5 shows surface pressure distribution for the seal configuration of the first embodiment with the seals being compressed where the seals are at the design position (FIG. 5A), misaligned 10% from the design position (FIG. 5B), and misaligned 20% from the design position (FIG. 5C).

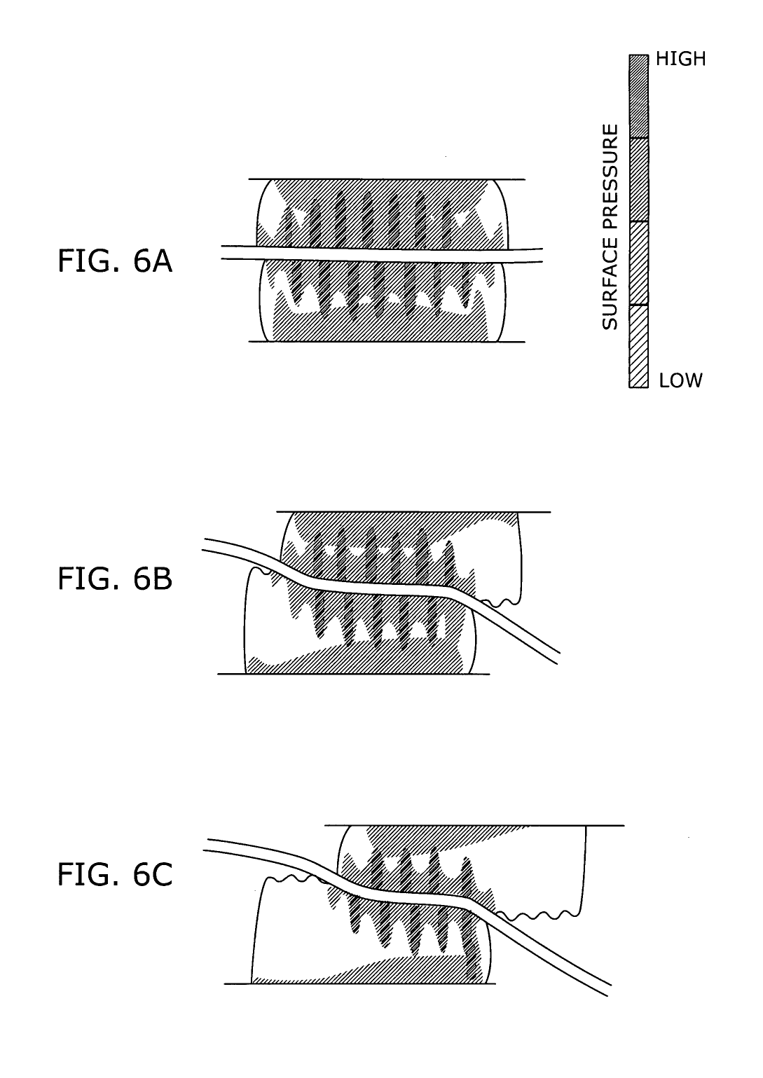

FIG. 6 shows surface pressure distribution for the seal configuration of the second embodiment with the seals being compressed where the seals are at the design position (FIG. 6A), misaligned 10% from the design position (FIG. 6B), and misaligned 20% from the design position (FIG. 6C). The percentage of misalignment used herein refers to the proportion to the seal width.

In FIGS. 4A and 4B, the region undergoing surface pressure is concentrated around the center of the engagement interface between the seals, and in that region, the portion with high surface pressure is narrow. In contrast, it is seen in FIGS. 5A, 5B, 6A, and 6B that the portion with high surface pressure is wide. The maximum surface pressure is increased by 30% in both FIGS. 4 and 5. In FIG. 4C, the upper and lower seal are out of engagement and fail to produce surface pressure to each other. This is because compression at 20% misaligned initial position results in displacement toward a larger amount of misalignment. However, in FIGS. 5C and 6C, the upper and lower seal are partially engaged with each other to produce surface pressure, and fuel leakage can be prevented.

Thus, according to the first and second embodiment, the seals can be extensively provided with high surface pressure, and are less susceptible to misalignment therebetween. Hence fuel leakage can be effectively prevented. Furthermore, particularly in the second embodiment, even if any misalignment from the design position occurs, the seals remains engaged at other protrusions and recesses, and are less susceptible to misalignment. Hence fuel leakage can be effectively reduced.

In the first embodiment, the protrusion and the recess can be reversed. That is, it is also possible to form a recess in the fuel electrode side seal 11, 21 and a protrusion in the oxidizer electrode side seal 12, 22.

In the second embodiment, the protrusions and recesses can be spaced equidistantly as in FIG. 3, but are not limited thereto. Furthermore, the protrusions and recesses can be mixed along the periphery in both the fuel electrode side seal 21 and the oxidizer electrode side seal 22. In FIG. 3, the protrusions or recesses in the fuel electrode side seal 21 can be in phase with the recesses or protrusions in the oxidizer electrode side seal 22, but the phase is not limited thereto.

In the second embodiment, the fuel electrode side seal and the oxidizer electrode side seal can be made of the same material as that used in the first embodiment.

The embodiments can be modified as appropriate without departing from the scope of the purpose of the invention.

1. A fuel cell seal comprising:
a first seal member having a first protrusion in a major surface thereof; and
a second seal member having a recess in a major surface thereof, the recess being engageable with at least part of the first protrusion.

2. The fuel cell seal according to claim 1, wherein the second seal member has a second protrusion in the recess.

3. The fuel cell seal according to claim 1, wherein the first seal member is made of elastic body.

4. The fuel cell seal according to claim 1, wherein the second seal member is made of elastic body.

5. The fuel cell seal according to claim 1, wherein the first and second seal members are shaped into a frame configuration.

6. The fuel cell seal according to claim 1, wherein the ratio of the height of the recess to the height of the second seal member is not less than 0.01 and not more than 0.5.

7. The fuel cell seal according to claim 1, wherein the first seal member has a plurality of the first protrusions, and the second seal member has a plurality of the recesses.

8. The fuel cell seal according to claim 7, wherein a spacing between the first protrusions and a spacing between the recesses are substantially same.

9. The fuel cell seal according to claim 1, wherein a hardness of at least one of the first and the second seal members is not smaller than 35 degrees.

10. The fuel cell seal according to claim 1, wherein a hardness of at least one of the first and the second seal members is smaller than 60 degrees.

11. A fuel cell comprising:
a solid electrolytic film;
a first and second seal member placed on both major surface sides of the solid electrolytic film, respectively, and opposed to each other;
a fuel electrode placed on a side of the first seal member, the side being opposite to the solid electrolytic film; and
an oxidizer electrode placed on a side of the second seal member, the side being opposite to the solid electrolytic film,
one of the first and the second seal members having a first protrusion,
other of the first and the second seal members having a recess engageable with at least part of the first protrusion, and
the first and the second seal members being engaged with each other across the solid electrolytic film.

12. The fuel cell according to claim 11, wherein the other of the first and the second seal members has a second protrusion in the recess.

13. The fuel cell according to claim 11, wherein the first seal member is made of elastic body.

14. The fuel cell according to claim 11, wherein the second seal member is made of elastic body.

15. The fuel cell according to claim 11, wherein the first and second seal members are shaped into a frame configuration.

16. The fuel cell according to claim 11, wherein the ratio of the height of the recess to the height of the other of the first and the second seal members is not less than 0.01 and not more than 0.5.

17. The fuel cell according to claim 11, wherein the one of the first and the second seal members has a plurality of the first protrusions, and the other of the first and the second seal members has a plurality of the recesses.

18. The fuel cell according to claim 17, wherein a spacing between the first protrusions and a spacing between the recesses are substantially same.

19. The fuel cell according to claim 11, wherein a hardness of at least one of the first and the second seal members is not smaller than 35 degrees.

20. The fuel cell according to claim 11, wherein a hardness of at least one of the first and the second seal members is smaller than 60 degrees.
